(19) United States
(12) Patent Application Publication
(10) Pub. No.: US 2015/0334530 A1
(43) Pub. Date: Nov. 19, 2015

(54) MONITORING SYSTEM AND METHOD

(71) Applicant: John Christian Scott, Cambridge (GB)

(72) Inventor: John Christian Scott, Cambridge (GB)

(73) Assignees: John Christian Scott, Cambridge (GB); Christian Bunke, Cambridge (GB)

(21) Appl. No.: 14/714,558

(22) Filed: May 18, 2015

(30) Foreign Application Priority Data
May 17, 2014 (GB) 1408778.7

(51) Int. Cl. H04W 4/02

(52) U.S. Cl. CPC H04W 4/027

(57) ABSTRACT

A monitoring system for monitoring spatial positions of user devices within a region is provided. The monitoring system includes at least one control centre arranged to be in communication, via a constellation of data hubs, with the devices. The user devices are operable to emit signals, which are received by one or more spatially-adjacent data hubs, which then communicate corresponding signals to the at least one control centre. An identity of the spatially adjacent data hubs is provided to the at least one control centre for the at least one control centre to determine therefrom the spatial positions of the user devices.

### TECHNICAL FIELD

The present disclosure relates to monitoring systems, for example, to monitoring systems for monitoring spatial locations of one or more user devices within a region. Moreover, the present disclosure concerns methods of monitoring spatial locations of one or more user devices within a region. Furthermore, the present disclosure relates to software products recorded on non-transient, namely non-transitory, machine-readable data storage media, wherein the software products are executable upon computing hardware for implementing aforementioned methods.

### BACKGROUND

Disasters:

Disasters can occur at any time. For example, a ship, named “Costa Concordia”, was grounded in January 2012. The ship was carrying 4,252 persons when it ran aground off the coast of Italy. After the grounding, passengers and crew were taken ashore from the ship by lifeboats and helicopters or swam to a nearby island, leaving about 40 persons missing. Half of these missing persons were found in following days inside the ship, most of them deceased. A final death toll was 32 persons.

A localized tracking solution would have allowed crew and rescue workers to locate all passengers as the aforementioned disaster happened as well as during an associated rescue operation. This would potentially have allowed rescue workers to save more lives, as they would have had accurate information about whereabouts of the missing persons, thereby enabling the rescue workers to concentrate their efforts on identified locations of the missing persons.

Locating Friends, Family or Colleagues: Large cruise ships weigh over 150,000 tonnes and can carry up to 6,000 passengers at a time. Cruise passengers often travel as a family, or as a group of friends. When travelling as a group, people often split off and “do their own thing”. It is desirable for a given member of a group to locate easily other members of his/her group, and possibly also send them a message, depending on technology used by a cruise company. For parents, being able to locate their children gives them peace of mind. They can, for example, leave their younger children in the child area and let their older children roam around, while they relax at an on-board swimming pool, massage parlour or casino.

On installations and other ships, being able to locate easily spatial positions of employees reduces time wasted locating and communicating with staff, thereby improving operating efficiency and/or safety. Other approaches, such as Global Positioning System (GPS) tracking devices and mobile phone technologies will often not work in these environments, and they do not provide a sufficiently satisfactory spatial tracking accuracy.

Man overboard: When a passenger falls overboard from a ship, the ship has to divert from its course and start a search and rescue operation to recover the overboard passenger. This search can cost hundreds of thousands, or even millions of dollars. Every year, there are between about 4 and 10 incidents of man/woman overboard. It is, therefore, desirable to employ a local tracking solution that would be able to identify that all passengers were on board.

Man down: When a person is down due to an accident, incident or medical condition, notifying relevant parties promptly can be a matter of life and death.

Cruise ships often have senior clientele onboard. As such, a likelihood of a medical emergency associated with such senior clientele is much greater than most other places. For example, elderly people can suffer from heart attacks, strokes or even simple slip and falls, all of which can be life-threatening if not treated quickly.

Locating Hostages & Victims In Terrorist Attacks: The “In Amenas” hostage crisis in January 2013 is an example that demonstrates where a localized tracking solution could potentially have saved lives. As a hostage or terrorist attack happens, special forces are often involved in an associated rescue attempt. It is desirable that security personnel know where hostages are located, in order to increase chances of implementing a successful rescue with minimal casualties.

In a case of attacks associated with the aforementioned “In Amenas” hostage crisis, at least one person crawled through a region desert and was rescued by military forces. In this case, a combined local and Iridium-based tracking system would have allowed security personnel to locate such escaping persons much faster.

Other events that require accurate knowledge of staff include piracy of ships. Most ships have a safe room, namely, a room where ship staff can take refuge. The location of such safe rooms is known only to most senior crew members. In an event of piracy, being able to locate and communicate with crew members efficiently is paramount.

Optimization of Operations: For cruise ships, ferries and hotels, it is desirable to optimize use of their space, be it commercially with respect to retail outlets, or be it with respect to other facilities. Tracking spatial locations of passengers, guests or customers within confines of a site onboard or in such cruise ships, ferries and hotels can enable a provider of the site to optimize his/her limited space in order to, for example, increase customer satisfaction as well as revenues.

There are several known technologies that have been used to provide local location tracking. Most of these known technologies are beneficially based on WIFI, Radio-Frequency Identification (RFID) or other radio-based technologies. Some contemporary providers of local tracking technologies are provided below in Table 1.

TABLE 1
Known tracking technologies

| Company | URL for Internet |
|---|---|
| Omnisense | http://www.omnisense.co.uk |
| Zebra Technologies | http://www.zebra.com/gb/en.html |
| Sensewhere | http://www.sensewhere.com/ |
| Ubisense | http://www.ubisense.net/ |

Omnisense: Omnisense has a technology platform that provides relative location tracking. This means that their tracking devices know where they are relative to each other. Omnisense's technology employs radio transmissions between the tracking devices, thereby enabling them mutually to communicate, regardless of a radio transmission frequency.

Zebra Technologies: Zebra technologies provide active RFID based location tracking systems and devices.

Sensewhere: Sensewhere provides a software product that combines Global Positioning System (GPS), Cell IDentification (CID), Bluetooth, Near Field Communication (NFC) and WIFI to provide an urban and indoor tracking. Their software product is designed to be used in conjunction with smart telephones.

A problem encountered with aforementioned known apparatus and methods is being able to track accurately through varied environments linking outdoor to indoor tracking and to address problems of shadowing, electrical noise, blocking structures, interference, asset/person mobility in high movement areas and so forth.

### SUMMARY

The present disclosure seeks to provide an improved monitoring system that is capable of addressing aforementioned problems.

Moreover, the present disclosure seeks to provide an improved method of monitoring spatial positions of one or more user-devices, in a manner that is capable of addressing aforementioned problems.

In a first aspect, embodiments of the present disclosure provide a monitoring system for monitoring spatial positions of one or more user devices within a region. The monitoring system includes at least one control centre arranged to be in communication, via a constellation of data hubs, with the user devices. Moreover, the user devices include a wireless interface for communicating with the data hubs.

The user devices are operable to emit signals, which are received by one or more data hubs that are spatially adjacent thereto (hereinafter referred as “spatially-adjacent data hubs”). The spatially-adjacent data hubs communicate corresponding signals to the at least one control centre, and provide their identity to the at least one control centre. This enables the at least one control centre to determine the spatial positions of the user devices.

Optionally, the user devices include a display for enabling the user devices to present information exchanged therebetween and/or received from the at least one control centre.

Optionally, the user devices include one or more motion sensors for monitoring motion of the user devices. The motion sensors provide corresponding motion data to the at least one control centre.

Optionally, the user devices are operable to switch between a low-power hibernating mode of operation and a full-power mode of operation in response to signals generated by the motion sensors. The low-power hibernating mode of operation beneficially consumes less power relative to the full-power mode of operation of the user devices.

Optionally, the user devices include one or more biometric sensors for monitoring a biological state of one or more associated users.

Optionally, the user devices include one or more ionizing (nuclear) radiation sensor for monitoring radiation exposure, for example arising from a release of radiation, for example in a nuclear-powered ship, submarine, nuclear power plant or similar. More optionally, the user devices include radiation shielding for shielding one or more electronic components of the user devices from the ionizing effects of radiation, for example a Lead or Bismuth radiation shield. By such an implementation, the user devices are well adapted for use in nuclear clean-up areas, for example in a vicinity of Fukushima Dai'ichi, Chernobyl and so forth.

Optionally, the user devices include at least one user-activated panic button for summoning assistance.

Optionally, the user devices include an acoustic transducer for enabling their detection when submerged in water.

Moreover, optionally, the user devices are user wearable. Optionally, the user devices are implemented as one or more of:

(a) a key card;

(b) a touch key card;

(c) a wrist band;

(d) an ankle band;

(e) a component in footwear;

(f) a head band;

(g) a helmet;

(h) a collar;

(i) a belt; and

(j) a component in clothing.

Moreover, optionally, the user devices are implemented to be wirelessly rechargeable. For example, resonant inductive charging is beneficially employed, which is highly efficient.

Moreover, optionally, the at least one control centre is operable to enable the user devices to be configured into one or more groups of user devices, and for information to be exchanged between user devices within each group.

Optionally, at least one of the groups is user-reconfigurable.

Optionally, a given user device is capable of concurrently belonging to a plurality of groups of user devices.

Furthermore, the monitoring system is adapted for use in at least one of:

(a) a vessel;

(b) a mine;

(c) a building;

(d) a building site;

(e) a petrochemicals facility;

(f) a nuclear-reactor facility; and/or

(g) a plant.

The monitoring system is of advantage in that it is capable of addressing aforementioned problems, namely, providing an improved tracking of the user devices.

In a second aspect, embodiments of the present disclosure provide a method of using the aforementioned monitoring system for monitoring the spatial positions of the user devices within the region.

In a third aspect, embodiments of the present disclosure provide a software product recorded on non-transitory (non-transient) machine-readable data storage media, characterized in that the software product is executable upon computing hardware of the aforementioned monitoring system, for implementing the aforementioned method.

In a fourth aspect, embodiments of the present disclosure provide a user device for use with the aforementioned monitoring system.

In a fifth aspect, embodiments of the present disclosure provide a method of installing the aforementioned monitoring system.

In a sixth aspect, embodiments of the present disclosure provide a software product recorded on non-transitory (non-transient) machine-readable data storage media, characterized in that the software product is executable upon computing hardware for implementing the method of installing the aforementioned monitoring system.

It will be appreciated that features of the invention are susceptible to being combined in various combinations without departing from the scope of the invention as defined by the appended claims.

### DESCRIPTION OF THE DIAGRAMS

Embodiments of the present disclosure will now be described, by way of example only, with reference to the following diagrams wherein:

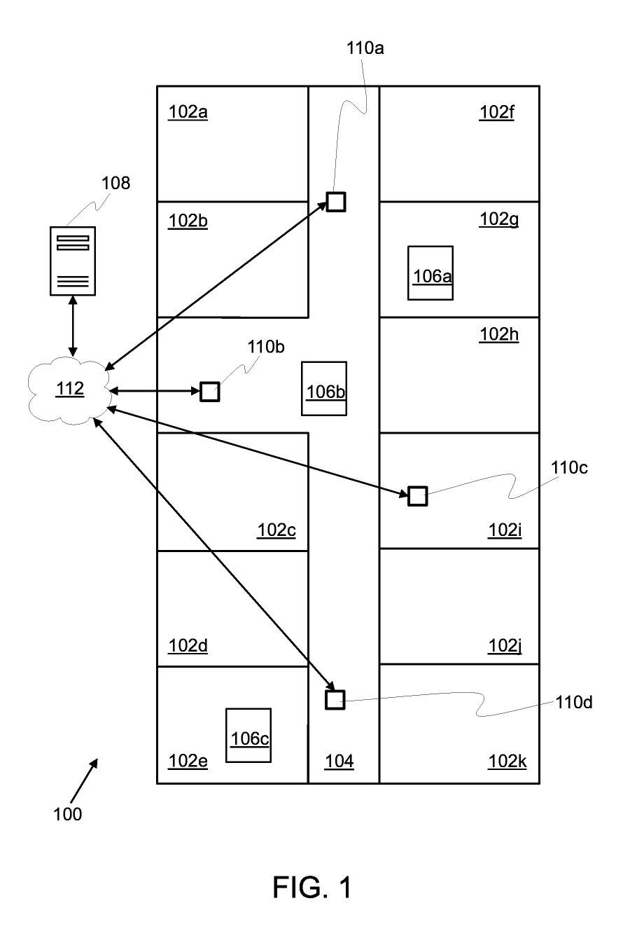

FIG. 1 is a schematic illustration of a monitoring system for monitoring spatial positions of one or more persons or assets within a region, in accordance with an embodiment of the present disclosure;

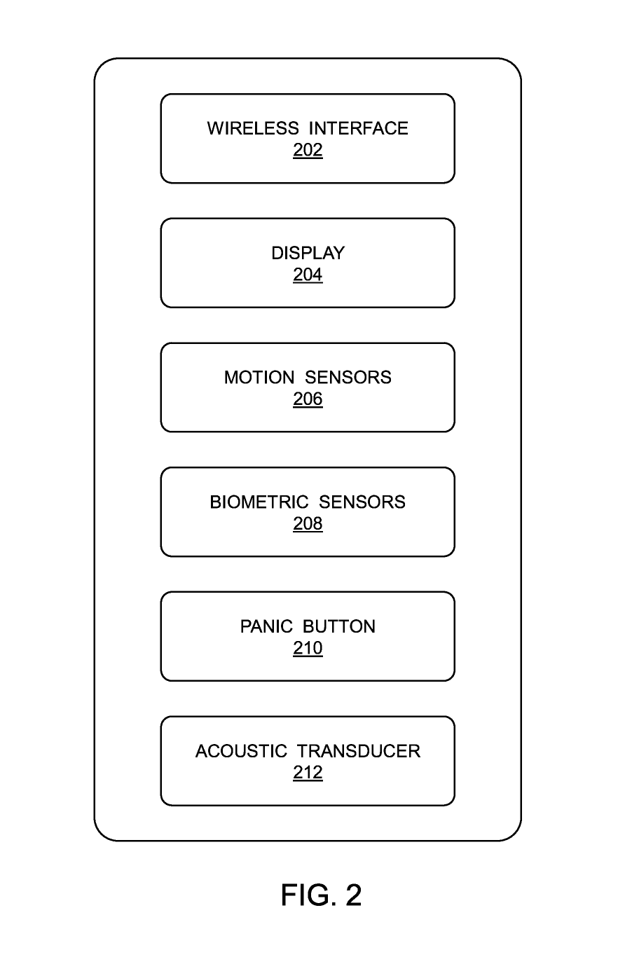

FIG. 2 is a schematic illustration of a user device, for use with the monitoring system of FIG. 1, in accordance with an embodiment of the present disclosure;

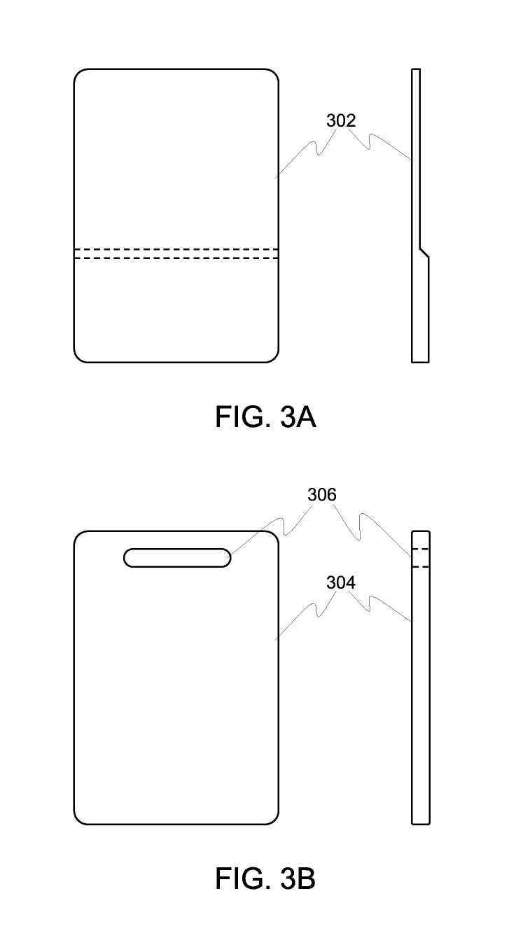

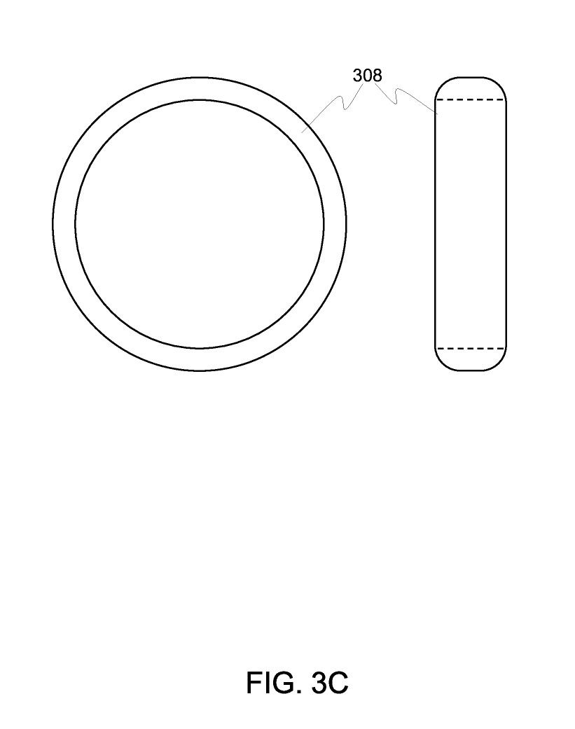

FIGS. 3A, 3B and 3C are a series of illustrations of user devices, for use with the monitoring system of FIG. 1, in accordance with embodiments of the present disclosure;

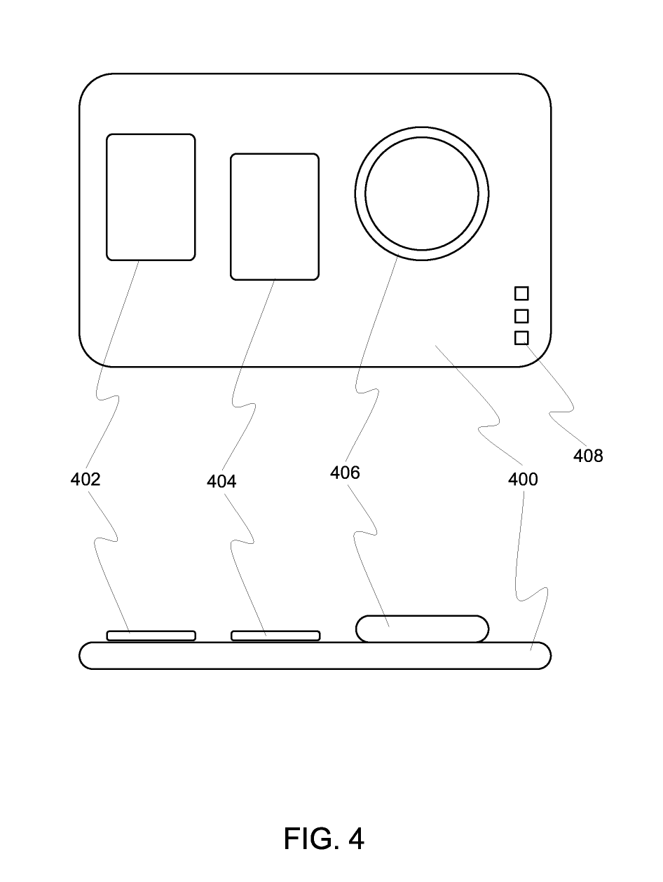

FIG. 4 is an illustration of a charging pod, in accordance with an embodiment of the present disclosure;

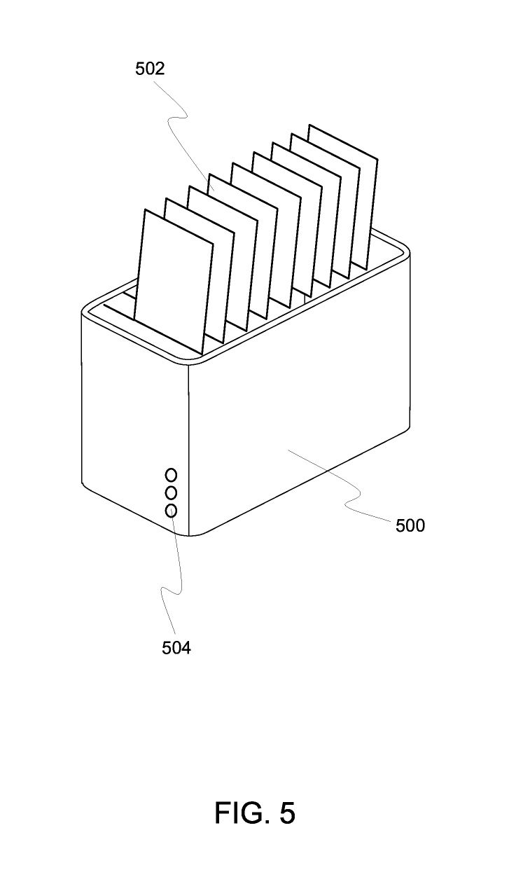

FIG. 5 is an illustration of a charging bay, in accordance with an embodiment of the present disclosure;

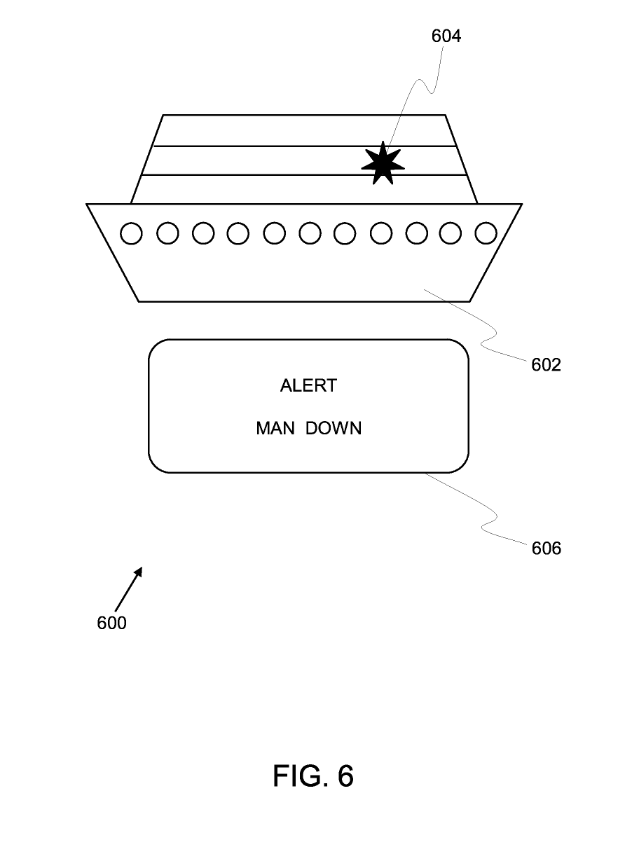

FIG. 6 is a schematic illustration of an example visualization generated by the monitoring system of FIG. 1, in accordance with an embodiment of the present disclosure;

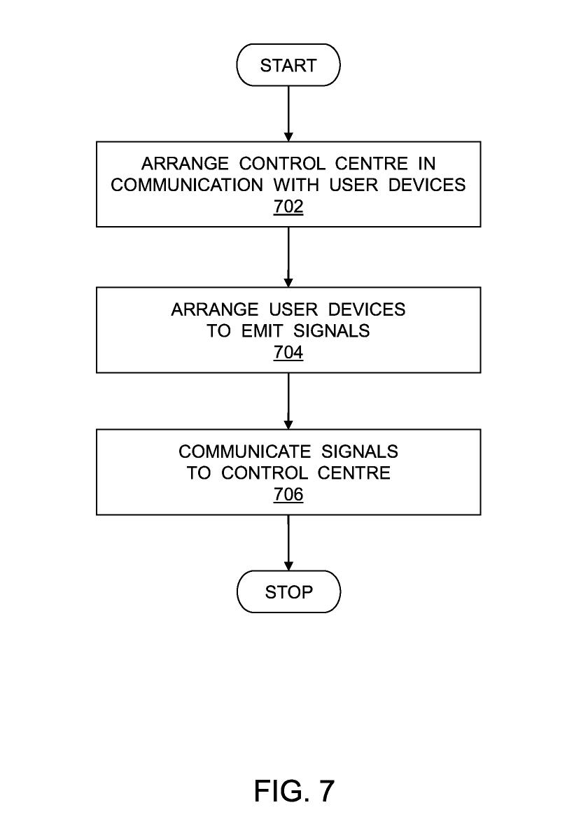

FIG. 7 is an illustration of steps of a method of using the monitoring system of FIG. 1, in accordance with an embodiment of the present disclosure; and

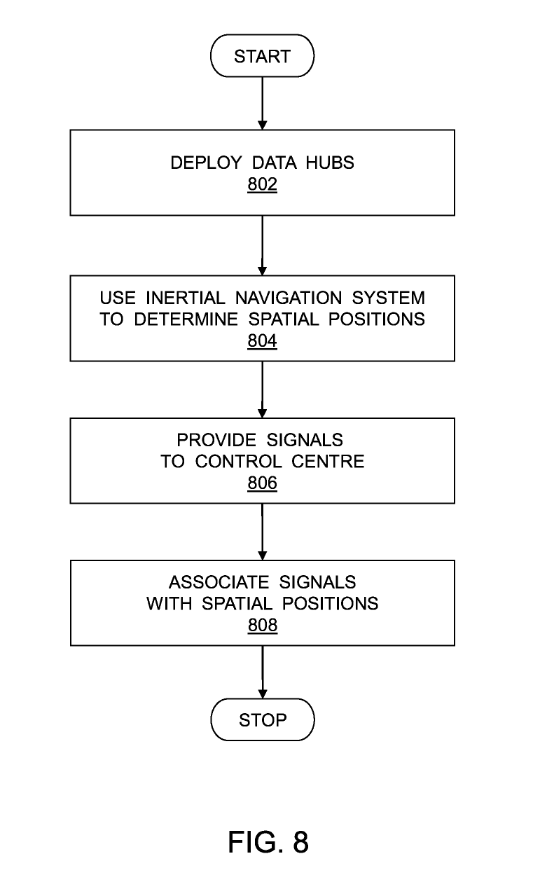

FIG. 8 is an illustration of steps of a method of installing the monitoring system of FIG. 1, in accordance with an embodiment of the present disclosure.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

In overview, embodiments of the present disclosure provide monitoring systems for monitoring spatial positions of one or more user devices within a given region. Beneficially, there is thereby provided monitoring of spatial positions of persons and assets within a local, confined or restricted space, which is important for safety, security and commercial reasons. Embodiments of the present disclosure concern, for example, a monitoring system for providing localized tracking, primarily for tracking people or assets within the given region. In an example, the monitoring system can be used to increase utilization of existing capacity and resources within the given region.

Examples of the given region include, but are not limited to:

(a) a vessel, such as a cruise ship, a passenger ship, a cargo ship, a special-purpose ship, a boat, an aircraft and the like;

(b) a mine;

(c) a building, such as a hospital, a school, a factory and the like;

(d) a building site;

(e) a petrochemicals facility, such as an oil refinery, an oil rig and the like;

(f) a nuclear-reactor facility, such as a nuclear-waste depository and the like; and

(g) a plant, such as a chemicals production plant, a power plant and the like.

Moreover, the monitoring system utilizes wireless tracking arrangements for determining spatial positions of passengers, crew members, staff members and any other person or asset within the given region. For this purpose, the monitoring system includes at least one control centre and a constellation of data hubs that are deployed at one or more known spatial positions within the given region.

Moreover, the user devices are operable to emit signals for enabling the monitoring system to monitor their spatial positions within the given region, as will be elucidated in greater detail below. These signals are received by one or more data hubs that are spatially adjacent to the user devices (hereinafter referred as “spatially-adjacent data hubs”). The spatially-adjacent data hubs then communicate the signals to the at least one control centre.

Moreover, an identity of the spatially-adjacent data hubs is provided to the at least one control centre to enable the at least one control centre to determine therefrom the spatial positions of the user devices. Herein, the spatially-adjacent data hubs beneficially act as fixed reference points relative to the given region.

In this manner, the at least one control centre monitors all of the user devices. Additionally, the at least one control centre notifies relevant parties when incidents happen, and assists in locating those affected. For this purpose, various visualization tools can be employed to display data collected from the user devices.

Moreover, the persons or assets being monitored beneficially wear or carry their respective user devices. In this regard, the user devices can be implemented as one or more of:

(a) a key card;

(b) a touch key card;

(c) a wrist band;

(d) an ankle band;

(e) a component in footwear;

(f) a head band;

(g) a helmet;

(h) a collar;

(i) a belt; and/or

(j) a component in clothing.

Optionally, the user devices communicate with each other and with the at least one control centre, via the data hubs, to provide an accurate spatial position of the persons or assets. This is useful in a case of an emergency or disaster, for example, the aforementioned sinking of the cruise ship, “Costa Concordia”, or the aforementioned attacks in “In Amenas”.

In a first example where the monitoring system is implemented in a cruise ship, the user devices are beneficially allocated to passengers of the cruise ship, for example, upon registration of a cruise. The user devices are beneficially integrally incorporated into cabin keys of the passengers and crew members. As the user devices need to be carried at all times, the user devices are suitably implemented as any of various forms described earlier.

Moreover, optionally, a user device of a particular passenger or crew member provides an identity of that particular passenger or crew member, for example, for purposes of shore leaves.

Optionally, the user devices act as a mode of payment for the passengers, throughout the cruise. Payment bills of passengers can be settled, for example, when the passengers return their user devices at the end of the cruise.

Moreover, the monitoring system can be used to save lives in an event of a disaster, such as a boat or ship capsizing, or an incident with a given person, such as a fall, a heart attack, or a man/woman overboard. Moreover, in an event of an attack on the cruise ship, the monitoring system can be used to locate the passengers and crew members to evacuate the cruise ship faster, and thus, reduce a potential number of casualties and deaths.

Moreover, optionally, the monitoring system allows the passengers and crew members to form one or more groups of user devices. This allows the passengers and crew members to know spatial positions of other members of their group.

Moreover, optionally, anonymized position data can be further analyzed for various purposes, namely, for improving utilization of resources and/or for increasing revenue and customer satisfaction.

In a second example where the monitoring system is implemented in a mine, the user devices can be allocated to miners, for example, when they check in and collect their helmets and lamps.

In the second example, the monitoring system is implemented for safety purposes. In an event of a disaster, such as cave-in, the monitoring system can be used to determine last known spatial positions of the miners, to allocate rescue services accordingly.

In a third example where the monitoring system is implemented in an oil rig, the user devices can be allocated to crew members upon arrival. The user devices can be returned and reallocated at a crew change.

The monitoring system can be used to save lives in an event of an incident with a given crew member, such as a man/woman overboard, a fall or a collapse due to dangerous or toxic gases.

Referring now to the drawings, particularly by their reference numbers, FIG. 1 is a schematic illustration of a monitoring system 100 for monitoring spatial positions of one or more persons or assets within a region, in accordance with an embodiment of the present disclosure. FIG. 1 shows a portion of the region that includes rooms 102a, 102b, 102c, 102d, 102e, 102f, 102g, 102h, 102i, 102j and 102k (hereinafter collectively referred as rooms 102), and a hallway 104.

The monitoring system 100 includes one or more user devices, depicted as user devices 106a, 106b and 106c in FIG. 1 (hereinafter collectively referred as user devices 106), at least one control centre, depicted as a control centre 108 in FIG. 1, and a constellation of data hubs, depicted as data hubs 110a, 110b, 110c and 110d (hereinafter collectively referred as data hubs 110).

The control centre 108 is arranged to be in communication, via the data hubs 110, with the user devices 106. For this purpose, the data hubs 110 are deployed at appropriate spatial positions within the region, in a manner that ensures that all areas of the region can be tracked. Further 3G, 4G and eventually 5G mobile networks may be used in the communication setup to further enhance the monitoring system's responsiveness and allowing engagement with users' more efficiently and enhancing the level of correct interpretation of the context of situations the users are in.

Optionally, the data hubs 110 are provided with electrical power from a main power supply (not shown) in the region. Additionally, optionally, each of the data hubs 110 is provided with a battery backup to ensure that the monitoring system 100 can handle power outages of the main power supply.

Moreover, the data hubs 110 are connected to a communication network 112 employed by the monitoring system 100. The communication network 112 communicably couples the data hubs 110 to the control centre 108, which is operable to control a monitoring service provided by the monitoring system 100.

The communication network 112 can be a collection of individual networks, interconnected with each other and functioning as a single large network. Such individual networks are beneficially wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, satellite-based telecommunication networks, and Worldwide Interoperability for Microwave Access (WiMAX) networks.

The communication network 112 is optionally implemented by way of a mesh network. Alternatively, the communication network 112 is implemented as a star-topology network; optionally, the control centre 108 is at a centre of the star-topology. Optionally, the communication network 112 is reconfigurable, for example on account of need for the communication network 112 to cope with different circumstances, for example a normal situation and an emergence situation. Such reconfiguration potentially provides for highest data communication rate in the normal situation, and a most reliable communication in an emergence situation, for example in an event that certain of the data hubs 110 are disabled in the emergency situation.

Moreover, the user devices 106 are operable to emit signals, while the data hubs 110 are operable to receive the signals emitted by the user devices 106. The data hubs 110 are operable to communicate the received signals to the control centre 108, for example, via the communication network 112.

As an example, a signal emitted by a given user device is received by one or more of the data hubs 110 that are spatially adjacent to the given user device (hereinafter referred to as spatially-adjacent data hubs). These spatially-adjacent data hubs communicate the received signal to the control centre 108. Additionally, the spatially-adjacent data hubs provide their identity to the control centre 108, wherefrom the control centre 108 determines a spatial position of the given user device within the region.

Likewise, each of the user devices 106 emits signals, which are received and communicated by their corresponding spatially-adjacent data hubs to the control centre 108. Thus, the control centre 108 is operable to determine spatial positions of the user devices 106 within the region.

The control centre 108 optionally includes one or more servers that are operable to process information, namely, data supplied by the user devices 106 via the data hubs 110, and are operable to take appropriate actions, when required.

Moreover, optionally, the user devices 106 are worn or carried by the persons or assets while moving within the region. Therefore, the spatial positions of the user devices 106 are the spatial positions of their corresponding persons or assets.

Moreover, optionally, the control centre 108 is operable to enable the user devices 106 to be configured into one or more groups of user devices. This potentially enables exchange of information between user devices within each group. This optionally allows groups of users to view each other's locations.

In an example of a cruise ship, the groups could include families and friends travelling together, for example. When travelling as a family on a cruise, family members often want to spend time doing activities away from other family members. As an example, parents with small children may want to spend time on a sun deck, while their children may want to play in a play area.

The monitoring system 100 optionally allows users to locate any member of their group or groups. This allows parents, for example, to monitor where their children are to be found, and friends to know where their friends are to be found.

In some examples, using web technologies, the users can access each other's locations via their computing devices. Examples of such computing devices include, but are not limited to, smart telephones, Mobile Internet Devices (MIDs), tablet computers, Ultra-Mobile Personal Computers (UMPCs), phablet computers, Personal Digital Assistants (PDAs), web pads, handheld Personal Computers (PCs), and laptop computers. In other examples, the users can access each other's locations via other interactive devices, for example, such as Television (TV) sets installed in their cabin rooms.

The user devices 106 can be linked together in groups, when registering the user devices 106 to the users.

Moreover, optionally, at least one of the groups is user-reconfigurable. For this purpose, the control centre 108 optionally allows users associated with user devices belonging to a given group, to reconfigure the given group, namely, to add or remove user devices to or from the given group. This beneficially allows the users to link their user devices together into groups.

Moreover, optionally, a given user device is capable of concurrently belonging to a plurality of groups of user devices.

Furthermore, the monitoring system 100 can be adapted for use in at least one of:

(a) a vessel, such as a cruise ship, a passenger ship, a cargo ship, a special-purpose ship, a boat, an aircraft and the like;

(b) a mine;

(c) a building, such as a hospital, a school, a factory and the like;

(d) a building site;

(e) a petrochemicals facility, such as an oil refinery, an oil rig and the like;

(f) a nuclear-reactor facility, such as a nuclear-waste depository and the like; and/or

(g) an industrial plant, such as a chemicals production plant, a power plant and the like.

Furthermore, optionally, the control centre 108 is operable to receive environmental data from other environmental systems implemented within the region. Optionally, the other environmental systems include, but are not limited to, one or more of:

(i) a fire detection system;

(ii) an access control system; and/or

(iii) a lighting system.

Accordingly, the control centre 108 is optionally operable to analyze the environmental data, received from the other environmental systems, to guide users associated with the user devices 106, for example, in a case of an emergency. For this purpose, the control centre 108 is optionally operable to populate an obstruction database with information about obstructions, for example, such as fire, water or blocked passages. The obstruction database may then be used to provide the users with a fastest or accessible evacuation route, for example, via displays and/or speakers included within the user devices 106.

In an example, when a given user device enters a zone within the region that the given user device is not authorized to access, the control centre 108 may send an alert to a system administrator. Consequently, the system administrator may then take an appropriate action, for example, such as sending security personnel to intercept the given user device and its associated user.

In a case of a disaster or an emergency, position data indicative of the spatial positions of the user devices 106 may be sent to an operations centre or headquarters of a security company for rescue and assistance purposes. This may be particularly beneficial in a case where the region's own security system fails. Optionally the security company may also be complemented by or replaced by government organisations, NGOs, military divisions, naval support units, or search and rescue operation units.

Moreover, the position data is beneficially anonymized for privacy purposes. Thus, the monitoring system 100 beneficially maintains anonymity in respect of the user devices 106 that are monitored by the monitoring system 100. Each of the user devices 106 is associated with a user, but an identity of the user is kept anonymous unless certain conditions are met. This means that there is no privacy implication associated with use of the monitoring system 100. The anonymity setting would optionally be as a default for any user but it may not be a required option in all applications.

In some instances, a captain of an associated cruise ship, a site manager or a person of equivalent authority can obtain information indicative of an identity of a given user provided with an associated user device. When the person of authority does access the identity of the given user, this information is logged and the person is accountable for this access. The identity is required to be accessed, for example, when a vessel capsizes and the users are still on board, when a passenger has fallen overboard, when an unauthorized access has been detected, or when there is an explosion or a collapse in a mine.

Although the position data is anonymous, some information can be associated with the user devices 106 and their associated users. A visualization tool could colour code or tag a representation of the users to indicate categorization data, for example, including one or more of:

(i) able-bodied person versus disabled person;

(ii) crew versus passenger; and/or

(iii) age category.

Categorization of the users into able-bodied person or disabled person is particularly beneficial in a rescue scenario, where a disabled person is likely to require extra assistance.

Categorization of the users into crew or passenger potentially ensures that only authorized personnel are accessing restricted areas. The user devices 106 are optionally colour coded or tagged to indicate their corresponding authorization level.

Age categorization is beneficial, as younger and older users are more vulnerable than other age groups. In order to ensure that users in these age categories receive an extra attention, colour coding or tagging their corresponding user devices can be beneficial. The colour coding or tagging of the user devices 106 may, for example, be implemented in a manner that is similar to their colour coding or tagging as presented at a control facility of the monitoring system 100. The monitoring system 100 optionally operates in one embodiment with limited or no interaction with the personnel or crew of an installation to decrease the risk of tampering or incorrect use.

Additionally, the position data can optionally be stored in an offsite secure location. Optionally, the monitoring system 100 stores the position data for as long as the system administrator requires the data. In an example, the monitoring system 100 is configured to store personal data of passengers of a cruise ship during a cruise. Storing the personal data is particularly beneficial in a case of an emergency or a disaster, and is essential for identification purposes in that case. Once the cruise is over, the monitoring system 100 could store only metadata for analysis purposes.

Optionally, the position data is stored using one or more database tables for performance purposes. In an example, a first database table may be used to store a most up-to-date spatial position for each user being tracked, while a second table may be used to store a timeline of each user, including past as well as present spatial positions. Both the first and second tables could include following fields:
UserID, Position, TimeStamp, Status,
   where
a field “UserID” represents an identity assigned to a given user;
a field “Position” represents a spatial position of the given user;
a field “TimeStamp” represents a time stamp associated with the spatial position of the given user, namely, a time at which the given user was at the spatial position; and
a field “Status” represents a status of the given user indicating, for example, a biological status of the given user, or whether the given user is moving or is still.

Moreover, additional database tables can be used to store information about the users including, for example, age, disability, grouping, and so forth.

Moreover, in some embodiments, the position data is sent to an analysis engine for a further analysis of the position data. The further analysis of the position data may, for example, provide information about where and when the users are spending their time. Such information is particularly beneficial to a cruise company or a site operator, depending on where the monitoring system 100 has been implemented. In an example, such information is particularly beneficial for purposes of determining trends and patterns in the users' behaviour, which could provide an insight of most popular zones and services provided by a cruise ship. This allows the cruise company to increase a commercial yield of their cruise and/or improve a cruising experience for the users.

Moreover, optionally, when a battery of a given user device is running low, namely, its charge is almost exhausted, the control centre 108 is operable to notify the system administrator about the situation. This beneficially allows the system administrator to replace the given user device with a fully-charged user device. Additionally or alternatively, a user associated with the given user device can optionally be notified, via a display and/or a speaker included within the given user device, and advised to recharge the given user device.

Moreover, optionally, the user devices 106 include motion sensors and/or biometric sensors that are operable to send motion and/or biological data of their users to the control centre 108. In an event that the control centre 108 detects that a given user has fallen or collapsed, based on the motion and/or biological data, the monitoring system 100 beneficially monitors a given user device associated with the given user more carefully, to ensure that the given user recovers, for example, gets up or stands again. If the given user device does not move even after a predefined time period, the control centre 108 is optionally operable to activate a “man-down” or “woman-down” alert, thereby notifying the system administrator and/or medically-trained staff that the given user has had a fall and is no longer moving. In an event that the control centre 108 stops receiving the biometric data from the given user device, the control centre 108 activates an emergency rescue operation for the given user. As aforementioned, the user devices 106 optionally include one or more ionizing radiation detectors, for example scintillation sensors, for detecting “hot spots” of radiation, for example during cleaning up after a nuclear accident. Optionally, the one or more ionizing radiation detectors are operable to detect radioactive “hot particles” which may be present in the region.

In an event that a given user disappears from the region, for example, when the given user falls over board from a vessel, the control centre 108 notices that a given user device associated with the given user has disappeared from the region. An accelerometer built into the given user device can be a key component in determining whether or not the given user has fallen overboard, as there will be more significant acceleration for a prolonged period in a case of a man-over-board scenario as compared to a regular fall scenario. When the control centre 108 detects that there is a man-over-board, the control centre 108 is optionally operable to activate a “man-over-board” alert, mutatis mutandis a “woman-over-board” alert. Additionally, the control centre 108 is optionally operable to collect position coordinates of the vessel, at a time when the given user falls over board, to provide a reference point to assist in an associated search and rescue operation. Additionally, advanced search and rescue analysis systems can then be activated to calculate a most likely location of the given user.

In an event of a given user accidentally venturing into unsuitable places on ships or installations, the monitoring system 100 optionally automatically activates emergency shutdown processes in order to ensure the safety of the given user.

Moreover, optionally, the monitoring system 100 can be integrated with other tracking systems, for example, such as a global tracking system, to provide a complete tracking solution. This may be particularly beneficial in an event of a person stowing away within the region, namely, when the person is in the region without a user device. In that event, the monitoring system 100 may automatically initiate a shutdown of the region, for example, via a secondary lockdown feature, and alert the system administrator about the event.

Furthermore, setting up the monitoring system 100 includes one or more of following tasks:

(i) creating a site model;

(ii) configuring the control centre 108;

(iii) installing the data hubs 110;

(iv) configuring the user devices 106; and/or

(v) configuring one or more charging arrangements.

Creating Site Model:

A site model of the region being monitored is created. The site model can be created based on architectural designs, for example, for a building or a vessel being monitored. The site model allows the user devices 106 to be overlaid correctly, for example when presented via a graphical user interface, thereby making it possible to identify a spatial position of a given user associated with a given user device, based upon a room from the rooms 102 or a zone of the region he/she are designated to occupy.

Additionally or alternatively, the site model can be created using measuring devices by taking spatial measurements of the rooms 102, the hallway 104 and/or various zones of the region. In an example, a laser measuring apparatus can be used to map out a structure of the region. In another example, a portable Inertial Navigation System (INS), namely, an autonomous measuring apparatus based upon gyroscopic sensors and accelerometers, can be used to map out the structure of the region by moving the portable INS around the region as a function of time, and noting environments in which the INS is present at a given time. Optionally, the INS is based on optical-fibre gyroscopic sensors and Silicon micro-machined accelerometers to obtain a high quality spatial measurement, namely a highly accurate spatial measurement. The INS is especially useful when the region is a mine, where old mine shafts and passages are retrospectively spatially mapped out for creating the site model. The INS is thus beneficially linked to a data logger, and is beneficially used in conjunction with a camera apparatus for monitoring environments in which the INS is brought. This allows the site model, for example, to have a visual record of various environments around the region, for example, for presenting to the users when they interrogate the monitoring system 100.

Configuring Control Centre:

The control centre 108 is beneficially configured so as to integrate the site model into the monitoring system 100, for example, for visualization purposes. This may optionally include configuring a display portal on which the site model may be displayed.

The control centre 108 is also configured for enabling communication with the data hubs 110.

Installing Data Hubs:

Positioning of the data hubs 110 is critical, as all areas of the region beneficially need to be monitored using the data hubs 110. For this purpose, the user devices 106 are moved throughout the entire region to ensure that all areas are susceptible to being monitored.

Each data hub is positioned in a manner that it can wirelessly communicate with at least one other data hub. For example, the data hubs 110 can be configured in a form of a relay network or a peer-to-peer network linked to the control centre 108.

Configuring User Devices:

Once a core infrastructure of the monitoring system 100 has been configured, the user devices 106 are also configured. As a part of their configuration, features to be provided by the user devices 106 are first defined. Subsequently, the user devices 106 are tested against the core infrastructure to ensure that they are working correctly.

Configuring Charging Arrangement:

Although the user devices 106 can be designed with replaceable batteries, the user devices 106 are optionally designed to be rechargeable. In some embodiments, the user devices 106 are water and dust resistant. Thus, recharging of the user devices 106 is beneficially implemented in a wireless manner, for example employing resonant inductive charging.

The monitoring system 100 optionally utilizes one or more of following wireless charging arrangements:

(i) charging pods;

(ii) charging bays; and/or

(iii) in-wall charging.

The user devices 106 are optionally designed to operate in a continuous manner or a pseudo-continuous manner without charging for weeks or potentially months. As such, charging may not be necessary, while the user devices 106 are in active use.

Example implementations of a charging pod and a charging bay have been provided in conjunction with FIGS. 4 and 5, respectively.

In-wall charging is a more disruptive charging arrangement, as compared to charging pods and charging bays. The in-wall charging typically involves embedding charging units into walls of each room, for example. An advantage of the in-wall charging is that the user devices 106 and other rechargeable devices can be charged substantially, in situ, for example, in cabin rooms of a cruise ship.

FIG. 1 is merely an example, which should not unduly limit the scope of the claims herein. It is to be understood that the specific designation for the monitoring system 100 is provided as an example and is not to be construed as limiting the monitoring system 100 to specific numbers, types, or arrangements of control centres, data hubs, and user devices. A person skilled in the art will recognize many variations, alternatives, and modifications of embodiments of the present disclosure.

FIG. 2 is a schematic illustration of a user device 200, for use with the monitoring system 100 of FIG. 1, in accordance with an embodiment of the present disclosure. The user device 200 is optionally implemented in a manner that is similar to the implementation of the user devices 106 and vice versa. For illustration purposes only, the user device 200 and its various components have been described in conjunction with the monitoring system 100 of FIG. 1.

The user device 200 includes a wireless interface 202, a display 204, and one or more motion sensors, depicted as motion sensors 206. The user device 200 optionally includes one or more biometric sensors, depicted as biometric sensors 208, a panic button 210, and an acoustic transducer 212.

The user device 200 also includes a power source (not shown) for providing electrical power to the various components of the user device 200. The power source may, for example, be a battery or other suitable power storage means.

The wireless interface 202 is operable to emit wireless signals and to communicate with the data hubs 110, for monitoring and tracking purposes described earlier. Moreover, the wireless interface 202 optionally enables the user device 200 to exchange information with other user devices of the monitoring system 100 and/or receive information from the control centre 108.

Optionally, the wireless interface 202 may employ Radio Frequency (RF) tracking technologies to enable the control centre 108 to determine a spatial position of the user device 200. Optionally, the RF tracking technology is based on, for example, Omnisense's mesh network technology, Radio Frequency Identification (RFID) technology similar to Zebra Technologies, or Ubisense's location technology, but not limited thereto.

Optionally, the wireless interface 202 can be provided by a low-power radio transmitter and/or receiver included within the user device 200.

The display 204 is operable to present, to a user associated with the user device 200, the information exchanged with the other user devices and/or received from the control centre 108, for example, in a case of an emergency.

In an example situation where an evacuation procedure is ongoing, the display 204 can be employed to present a fastest or accessible evacuation route and a current spatial position of the user, for example, on a schematic map of the region. This can help save lives as the user may otherwise end up trying a standard evacuation route, which may be inaccessible, wasting precious time.

Additionally, optionally, the display 204 is operable to alert the user in a case of a low battery charge.

Moreover, optionally, the user device 200 may include a speaker (not shown) embedded therein. The speaker can be employed to provide personalized instructions to the user, in an event of an incident or an emergency. The speaker may be particularly beneficial for those who are visually impaired, in which case the personalized instructions could pertain to physiological as well as environmental factors associated with the user, for example, such as a power outage or an occurrence of smoke.

For users with hearing disabilities, the display 204 can be employed to relay any key information about an incident, for example.

Optionally, the user device 200 may include a vibrator (not shown) embedded therein. Optionally, the vibrator is operable to produce a vibration or a buzzing sensation to alert the user about an incident, for example, such as an emergency.

Moreover, the vibrator may be beneficial in certain security situations, and/or for those who are hearing impaired. For example, the vibrator may be beneficial for attracting the user's attention towards the display 204 displaying some useful information.

Optionally, the vibrator can be implemented as a mass on a compliant mount, thereby forming a resonant mass-spring system, which can be excited into its fundamental mode of resonance, for example, via a magnetic transducer. The fundamental mode of resonance has a resonance frequency that is optionally in a range of 8 Hz to 30 Hz. Alternatively, optionally, the vibrator can be implemented using an eccentric rotating mass.

In an example situation of an attack or a hijack, it is vital that all communications are silent, reducing a chance of attackers being alerted of a location of the user. Accordingly, in such a situation, the control centre 108 optionally sends instructions to the user device 200 to switch off the speaker and/or the vibrator. Alerts and information may then be presented to the user via the display 204.

Moreover, the motion sensors 206 are operable to monitor motion of the user device 200, and to provide corresponding motion data to the control centre 108, via the wireless interface 202 and the data hubs 110. The control centre 108 is then operable to analyze the motion data and to trigger appropriate actions, when required. The motion data allows the control centre 108 to determine, for example, if the user is down and unconscious or if the user has fallen overboard.

Optionally, the motion sensors 206 include, but are not limited to, accelerometers, and gyroscopic sensors.

Moreover, optionally, the user device 200 is operable to switch between a low-power hibernating mode of operation and a full-power mode of operation in response to signals generated by the motion sensors 206. The low-power hibernating mode of operation consumes less power in the user device 200 relative to the full-power mode of operation of the user device 200. This can potentially provide significant power savings, thereby prolonging operation of the user device 200 between recharges.

In an example situation where the user is sitting or lying down, the motion sensors 206 detect that the user is not moving. Accordingly, the motion sensors 206 generate a signal based on which the user device 200 switches from the full-power mode of operation to the low-power hibernating mode of operation. When the user starts moving again, the motion sensors 206 detect that the user is moving. Accordingly, the motion sensors 206 generate another signal based on which the user device 200 switches from the low-power hibernating mode of operation to the full-power mode of operation. For example, once the user device 200 moves by more than a threshold distance, and/or is subject to more than a threshold acceleration, and/or is subject to more than a threshold rate of angular rotation, the user device 200 switches to the aforementioned full-power mode of operation.

Moreover, the biometric sensors 208 are operable to monitor a biological state of the user associated with the user device 200. Optionally, the biometric sensors 208 are operable to provide corresponding biological data to the control centre 108, via the wireless interface 202 and the data hubs 110. The control centre 108 is then operable to analyze the biological data and to trigger appropriate actions, when required.

Optionally, the biometric sensors 208 include, but are not limited to, a pulse sensor. In an example situation where the user has fallen over and his/her pulse has stopped, the monitoring system 100 will automatically know that there is an issue and activate an appropriate response for invoking support from medically-trained staff.

In another example situation where a search and rescue operation is ongoing, knowing which users have a pulse and are still alive can improve a response of the search and rescue operation as rescue can be directed to the right victims.

In yet another example situation where a large number of cruise passengers are elderly people, who are more likely to suffer a serious incident, be that a stroke or a heart attack or a trip and fall, the biometric sensors 208 combined with the motion sensors 206 help identify issues almost instantaneously. This significantly reduces a risk of permanent injury or death.

The biometric sensors 208 can be particularly useful when the user device 200 is implemented in a format that allows the user device 200, when worn, to be in a close contact with the user's body, for example, such as a wrist band. Moreover, apart from the motion sensors 206 and the biometric sensors 208, the user device 200 may optionally include other sensors, for example, including at least one of:

(i) one or more gas sensors for detecting a presence of flammable or poisonous gases, for example, when the user goes into a mine where such gases are likely to be encountered;

(ii) one or more temperature sensors for detecting extreme temperatures in a proximity of the user, for example, in an event of a fire; and/or

(iii) one or more radiation sensors for detecting an exposure to nuclear radiation, for example, when the user is under nuclear exposure in a nuclear-reactor facility.

Moreover, the panic button 210 can be activated by the user for summoning assistance. When activated, the panic button 210 is operable to notify the control centre 108 about a problem or an issue involving the user.

In order to reduce false positives, the panic button 210 is optionally designed so as to require more than a touch to activate its associated functions. In an example, the panic button 210 can be implemented as two buttons on substantially opposite sides of the user device 200, both of which need to be pressed simultaneously to invoke their associated functions. In another example, the panic button 210 can be implemented in a hidden or recessed manner that requires a flap or a slider to be removed in order to access the panic button 210. Alternatively, the panic button 210 can be implemented so that a user of the user device 200 depresses at least one button of the user device 200, wile simultaneously shaking the user device 200, to indicate an occurrence of a panic state; such a manner of indicating the panic state potentially avoids the user inadvertently, in error, indicating a panic state.

Moreover, the acoustic transducer 212 enables detection of the user device 200 when submerged in water. This allows the monitoring system 100 to determine the spatial position of the user device 200, even when submerged in water.

Optionally, the acoustic transducer 212 can be implemented by way of a piezoelectric transducer.

Furthermore, optionally, the user device 200 is user-wearable. In this regard, the user device 200 can have any suitable design that allows its user to carry or wear the user device 200 with ease. As an example, the user device 200 can be implemented as one or more of:

(a) a key card;

(b) a touch key card;

(c) a wrist band;

(d) an ankle band;

(e) a component in footwear;

(f) a head band;

(g) a helmet;

(h) a collar;

(i) a belt; and/or

(j) a component in clothing.

Some example implementations of the user device 200 have been provided in conjunction with FIGS. 3A-C.

Key factors while designing the user device 200 could include one or more of:

(i) size;

(ii) weight;

(iii) ease of use; and/or

(iv) battery life.

Moreover, optionally, the user device 200 is implemented to be wirelessly rechargeable. Example implementations of a charging arrangement have been provided in conjunction with FIGS. 4 and 5.

In an embodiment, the user device 200 is implemented as a low power device, which is optionally charged using the user's body heat. For this purpose, the user device 200 includes a thermoelectric generator, which is operable continuously to charge the user device 200 while being worn by the user.

In another embodiment, the user device 200 is implemented so as to be chargeable by kinetic energy generated from movements of the user device 200, for example, in a manner that is similar to kinetic charging implemented in respect of conventional wrist watches. Further, in order to determine that the correct asset or person is wearing the tracking device or wearable device, e.g. in a hijacking scenario, identification methods such as biometrics, DNA, fingerprint, voice or other analysis could be used to determine who is wearing the device. Even heat, pulse, movement sensors could be used to determine that the wearable device is being worn. This would prevent confusion or errors of a person removing a wearable device and/or someone else puts it on, or a person take the wearable device off and throw it into the sea or disposing of it in other ways.

In an example implementation, the user device 200 includes a low-power radio transmitter and/or receiver for providing the wireless interface 202. This beneficially allows the user device 200 to operate for durations of weeks or months between recharges. Optionally, the region is implemented as a low-power resonant inductive charging zone, and the user device 200 is operated in an intermittent pulse mode while being continuously charged at a low recharging rate, so that batteries of the user device 200 never become fully discharged.

In some embodiments, the user device 200 includes a limited number of features, for example, doing away with extra features, such as the display 204, the speaker, the vibrator, the motion sensors 206, the biometric sensors 208, and the panic button 210. This potentially increases its battery life, which is highly desirable during a search and rescue operation, for example. This also reduces its overall size and its cost of manufacture. Example of wearable technology that optionally could be integrated or interact with the monitoring system 100 include but are not limited by Nike's fuelband, Google glasses, Apple's iwatch, or Fitbit's wearable devices as well as Mobile Application software solutions.

Furthermore, optionally, the user device 200 is designed to be water and dust resistant. Additionally, optionally, the user device 200 is designed to be shock and impact resistant, thereby making it durable, for example, when dropped onto a hard floor, when sat upon, when trodden upon, and so forth. In an example implementation where the monitoring system 100 is implemented in a cruise ship, a cruise passenger will carry his/her user device with him/her at all times, be that going to a pool or a beach, or visiting a massage parlour. In another implementation where the monitoring system 100 is implemented in an oil rig, an oil worker may be subjected to potentially hazardous scenarios. As such, the user device 200 may be beneficially designed to meet a standard required for use on oil and gas installations, for example, complying with British Approval Service for Electrical Equipment in Flammable Atmospheres (BASEEFA) and similar safety standards.

FIG. 2 is merely an example, which should not unduly limit the scope of the claims herein. A person skilled in the art will recognize many variations, alternatives, and modifications of embodiments of the present disclosure.

FIGS. 3A, 3B and 3C are a series of illustrations of user devices, for use with the monitoring system 100 of FIG. 1, in accordance with embodiments of the present disclosure.

FIG. 3A shows a front view and a side view of a user device 302, in accordance with an embodiment of the present disclosure. The user device 302 is in a form of a key card, as shown in FIG. 3A.

The user device 302 can be implemented as a modified version of a standard key card, for example, for a cabin or hotel room. The user device 302 works in a manner that is similar to the standard key card that, when slipped into a slot or swiped in a reader associated with a door, provides access to the cabin or hotel room. The user device 302 is particularly useful in environments that use existing slot-based door locks.

Optionally, one end of the user device 302 is made slightly thicker than another end that is made to slip into the slot, to accommodate a power source and electronics of the user device 302.

FIG. 3B shows a front view and a side view of a user device 304, in accordance with another embodiment of the present disclosure. The user device 304 is in a form of a touch key card, as shown in FIG. 3B.

The user device 304 can be implemented as a modified version of a standard touch or Near Field Communication (NFC) key card (hereinafter referred as “touch key card”). The user device 304 works in a manner that is similar to the standard touch key card that does not require slipping into a slot or swiping in a reader, but merely requires touching an access panel or a lock to unlock a door.

From a design perspective, the user device 304 can have an external appearance similar to the user device 302. As the user device 304 does not require fitting into a slot or a reader, the user device 304 can have a same thickness throughout. This makes the user device 304 slightly more comfortable for a user to carry. Additionally, optionally, the user device 304 can be designed to include a hole 306, which allows the user to attach the user device 304 to a key ring.

In FIG. 3C, there is shown a front view and a side view of a user device 308, in accordance with yet another embodiment of the present disclosure. The user device 308 is in a form of a wrist band, as shown in FIG. 3C. In many respects, the user device 308 is a preferred form pursuant to embodiments of the present disclosure. Optionally, the user device 308 works in a manner that is similar to the user devices 302 and 304, but is shaped as a flexible wrist band.

Optionally, the user device 308 can be provided in multiple sizes, for example, ranging from sizes for toddlers to large adults. Optionally, the user device 308 has a removable cover so as to allow the user to customize and personalize it as per his/her taste, for example, to include a photograph of a latest pop star or a movie.

Optionally, the user device 308 is manufactured from rubber or other durable elastic materials, for example, such as a polyurethane material, a silicone-based material and the like.

Optionally, the user device 308 includes one or more electronic modules within a core of the wrist band. The user wears his/her wrist band at all times, for example, during a session or a cruise. An advantage of the wrist band is that the user is unlikely to misplace or leave his/her wristband behind, as it is attached to him/her at all times. Therefore, it is essential that the wrist band is resistant to water, dust, sand and shock.

In FIGS. 3A-C, there are shown merely examples, which should not unduly limit the scope of the claims herein. A person skilled in the art will recognize many variations, alternatives, and modifications of embodiments of the present disclosure.

FIG. 4 is an illustration of a charging arrangement 400, in accordance with an embodiment of the present disclosure. In FIG. 4, there is shown a top view and a front view of the charging arrangement 400.

Optionally, the charging arrangement 400 is a wireless charging unit. Optionally, the charging arrangement 400 employs resonant inductive charging, which is highly efficient and enables considerable power to be coupled, despite of user devices being of modest physical size.

The charging arrangement 400 is in a form of a charging pod, which is optionally integrated into, for example, a user's cabin room. In operation, when charging, user devices 402, 404 and 406 are put onto a top of the charging pod, for example, overnight, allowing the user devices 402, 404 and 406 to recharge.

The charging arrangement 400 optionally includes a display or Light Emitting Diode (LED) lights, depicted as LED lights 408, to indicate a charging status of each user device put onto its top.

The charging pod and charging mechanism in the user devices 402, 404 and 406 optionally employ a similar charging technology as used to charge contemporary mobile phones and other devices. This enables the charging arrangement 400 to be used by multiple devices, namely, user devices pursuant to embodiments of the present disclosure, contemporary mobile phones and other contemporary devices.

The charging arrangement 400 can easily be implemented into existing rooms with limited disruption.

FIG. 4 is merely an example, which should not unduly limit the scope of the claims herein. A person skilled in the art will recognize many variations, alternatives, and modifications of embodiments of the present disclosure.

FIG. 5 is an illustration of a charging arrangement 500, in accordance with another embodiment of the present disclosure. In FIG. 5, there is shown an isometric view of the charging arrangement 500.

The charging arrangement 500 is in a form of a charging bay. The charging bay is beneficially employed to charge several user devices, depicted as user devices 502, at a same time.

Optionally, the charging arrangement 500 provides wireless charging of the user devices 502. For this purpose, the user devices 502 are slotted into receiving ports of the charging arrangement 500.

Optionally, a charging manager monitors a charging status of all of the user devices 502 being charged. Optionally, the charging arrangement 500 includes a display or LED lights, depicted as LED lights 504, to indicate a charging status of each user device slotted into the receiving ports of the charging arrangement 500.

An array of charging bays can be located on-site or at an off-site location. For a cruise ship, such an off-site location may be a warehouse at a main departure port. At the end of a given cruise, a set of discharged user devices are taken to the warehouse for recharging, and a new set of fully-charged user devices are allocated to the cruise ship for a next cruise.

In a mine, charging bays can be located at a check-in point for the mine. The user devices can be charged at the check-in point, for example, in a manner that is similar to miners' helmets that have flashlights attached thereto, which are charged on a regular basis. The charging of the user devices is beneficially coordinated with the charging of batteries of the flashlights.

FIG. 5 is merely an example, which should not unduly limit the scope of the claims herein. A person skilled in the art will recognize many variations, alternatives, and modifications of embodiments of the present disclosure.

FIG. 6 is a schematic illustration of an example visualization 600 generated by the monitoring system 100, in accordance with an embodiment of the present disclosure. For illustration purposes only, the visualization 600 pertains to a scenario where the monitoring system 100 has been implemented in a cruise ship.

The visualization 600 can be presented to a system administrator of the monitoring system 100, for example, via a computing device. Examples of the computing device include, but are not limited to, a mobile phone, a smart telephone, an MID, a tablet computer, a UMPC, a phablet computer, a PDA, a web pad, a PC, a handheld PC, a laptop computer, a desktop computer, and a large-sized touch screen with an embedded PC.

Visualizations generated by the monitoring system 100, such as the visualization 600, optionally enable the system administrator to:

(i) view the spatial positions of the user devices 106 at a given particular moment, for example, such as a present or a past moment;

(ii) view any issues or problems faced by the users and/or within the region; and/or

(iii) add, remove or modify an authorization level of a given user.

Additionally or alternatively, the visualization 600 can be presented to a rescue team or medically-trained staff, for example, in an event of a search and rescue operation or a medical emergency. For this purpose, the visualization 600 can be provided to a portable device carried by the rescue team or the medically-trained staff, via an Application Program Interface (API), thereby allowing them to access all relevant information from the monitoring system 100. Optionally, the portable device can be integrated into a wearable technology worn by the rescue team or the medically-trained staff.

Additionally or alternatively, optionally, the monitoring system 100 provides visualization tools displaying a view of a given situation that is relevant to the rescue team or the medically-trained staff. Additionally, optionally, the monitoring system 100 generates a rescue plan incorporating a risk scenario analysis and/or associated success probabilities.

Optionally, the visualization 600 is built around web technologies, such as HyperText Markup Language (HTML) 5, although other technologies can alternatively or additionally be used. Use of the web technologies allows the visualization 600 to be viewed on various types of computing devices, without a need for employing dedicated software applications, namely, “Apps”.

Optionally, the visualization 600 includes a console view 602, which is beneficially employed as a two-dimensional (2D) and/or a three-dimensional (3D) site model of the region being monitored. Optionally, the console view 602 shows the spatial positions of the user devices 106 and hence their associated users. Accordingly, the console view 602 optionally employs individual markers for each user and/or cluster markers for groups of users.

Optionally, a distressed marker, such as a flashing marker, is employed for a given user who is in distress. With reference to FIG. 6, a distressed marker 604 is shown on a superstructure of the cruise ship. The distressed marker 604 alerts the system administrator about a distressed user.

Optionally, the visualization 600 allows the system administrator to zoom in or out, pan and/or rotate the console view 602, thereby providing different views from different angles.

Optionally, the visualization 600 allows the system administrator to apply various filters on certain parameters configured in the monitoring system 100, for example, such as age, a physical health status and so forth. The physical health status may, for example, indicate whether a given user is young or old, is able or disabled, and/or is dead or alive. This may be particularly beneficial during a search and rescue operation, where a rescue team needs to prioritize those most in need and those who are still alive.

Apart from the console view 602, the visualization 600 includes a text view 606 that provides details of the distressed user including, for example, his/her biological state, whether he/she is moving or not, and so on. With reference to FIG. 6, the text view 606 shows a “man-down” or “woman-down” alert activated by the control centre 108 of the monitoring system 100, as an example.

Furthermore, optionally, the monitoring system 100 can generate analytical visualizations to present analytical data for demonstration purposes. In an example, a timeline video of a given user's movement can be presented to the system administrator, for example, in an event of an unauthorized access. From an analysis point of view, the monitoring system 100 optionally generates analytical reports based on various criteria including, for example, a specific location and/or a specific date.

FIG. 6 is merely an example, which should not unduly limit the scope of the claims herein. A person skilled in the art will recognize many variations, alternatives, and modifications of embodiments of the present disclosure.

FIG. 7 is an illustration of steps of a method of using a monitoring system for monitoring spatial positions of one or more user devices within a region, in accordance with an embodiment of the present disclosure. The method is depicted as a collection of steps in a logical flow diagram, which represents a sequence of steps that can be implemented in hardware, software, or a combination thereof.

For illustration purposes only, the method has been illustrated with reference to the monitoring system 100 as described in conjunction with FIG. 1.

At a step 702, at least one control centre is arranged to be in communication, via a constellation of data hubs, with the user devices.

In accordance with the step 702, the at least one control centre, the constellation of data hubs and the user devices can be implemented in a manner that is similar to the implementation of the control centre 108, the data hubs 110 and the user devices 106, respectively, described earlier in conjunction with FIG. 1.

At a step 704, the user devices are arranged to be operable to emit signals, which are received by one or more data hubs that are spatially adjacent thereto.

Next, at a step 706, the data hubs communicate corresponding signals to the at least one control centre.

In accordance with the step 706, the data hubs provide their identity to the at least one control centre. This enables the at least one control centre to determine the spatial positions of the user devices, as described earlier.

The steps 702 to 706 are only illustrative and other alternatives can also be provided where one or more steps are added, one or more steps are removed, or one or more steps are provided in a different sequence without departing from the scope of the claims herein.

Embodiments of the present disclosure provide a software product recorded on non-transitory (non-transient) machine-readable data storage media, wherein the software product is executable upon computing hardware for implementing the method as described in conjunction with FIG. 7.

FIG. 8 is an illustration of steps of a method of installing a monitoring system for monitoring spatial positions of one or more user devices within a region, in accordance with an embodiment of the present disclosure. The method is depicted as a collection of steps in a logical flow diagram, which represents a sequence of steps that can be implemented in hardware, software, or a combination thereof.

At a step 802, one or more data hubs of the monitoring system are deployed at one or more appropriate spatial positions within the region. In accordance with the step 802, the data hubs are deployed in a manner that ensures that all areas of the region can be tracked, as described earlier.

At a step 804, an INS is used to determine spatial positions of the user devices within the region.

In accordance with the step 804, the INS optionally uses one or more of:

(i) previous known spatial positions of the user devices; and/or

(ii) motion data gathered from motion sensors included within the user devices.

From knowledge of the previous known spatial positions and the motion data, the INS is optionally operable to determine the spatial positions of the user devices within the region.

At a step 806, the data hubs provide signals received from the user devices to at least one control centre of the monitoring system.

Consequently, at a step 808, the at least one control centre associates the signals provided by the data hubs with corresponding spatial positions of the user devices.

The steps 802 to 808 are only illustrative and other alternatives can also be provided where one or more steps are added, one or more steps are removed, or one or more steps are provided in a different sequence without departing from the scope of the claims herein.

Embodiments of the present disclosure provide a software product recorded on non-transitory (non-transient) machine-readable data storage media, wherein the software product is executable upon computing hardware for implementing the method as described in conjunction with FIG. 8.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

We claim:

1. A monitoring system for monitoring spatial positions of one or more user devices within a region, characterized in that the monitoring system includes at least one control centre arranged to be in communication, via a constellation of data hubs, with the one or more user devices, wherein the one or more user devices are operable to emit signals, which are received by one or more data hubs that are spatially adjacent thereto and that communicate corresponding signals to the at least one control centre, wherein an identity of the one or more data hubs is provided to the at least one control centre for the at least one control centre to determine therefrom the spatial positions of the one or more user devices.

2. The monitoring system as claimed in claim 1, characterized in that the one or more user devices include a display for enabling the one or more user devices to present information exchanged therebetween and/or received from the at least one control centre.

3. The monitoring system as claimed in claim 1, characterized in that the one or more user devices include one or more motion sensors, and are operable to switch between a low-power hibernating mode of operation and a full-power mode of operation in response to signals generated by the one or more motion sensors, wherein the low-power hibernating mode of operation consumes less power in the one or more user devices relative to the full-power mode of operation of the one or more user devices.

4. The monitoring system as claimed in claim 1, characterized in that the one or more user devices include one or more of:
(a) one or more motion sensors for monitoring motion of the one or more user devices and for providing corresponding motion data to the at least one control centre;
(b) one or more biometric sensors for monitoring a biological state of one or more users associated with the one or more user devices; and
(c) one or more ionizing radiation sensors for measuring ionizing radiation exposure.

5. The monitoring system as claimed in claim 1, characterized in that the one or more user devices include at least one user-activated panic button for summoning assistance.

6. The monitoring system as claimed in claim 1, characterized in that the one or more user devices include a wireless interface for communicating with the one or more data hubs, and an acoustic transducer for enabling their detection when submerged in water.

7. The monitoring system as claimed in claim 1, characterized in that the one or more user devices are user wearable.

8. The monitoring system as claimed in claim 7, characterized in that the one or more user devices are implemented as one or more of:
(a) a key card;
(b) a touch key card;
(c) a wrist band;
(d) an ankle band;
(e) a component in footwear;
(f) a head band;
(g) a helmet;
(h) a collar;
(i) a belt;
(j) a component in clothing.

9. The monitoring system as claimed in claim 1, characterized in that the one or more user devices are implemented to be wirelessly rechargeable.

10. The monitoring system as claimed in claim 1, characterized in that the at least one control centre is operable to enable the one or more user devices to be configured into one or more groups of user devices, and for information to be exchanged between user devices within each group.

11. The monitoring system as claimed in claim 10, characterized in that a given user device is capable of concurrently belonging to a plurality of groups of user devices.

12. The monitoring system as claimed in claim 10, characterized in that at least one of the one or more groups is user-reconfigurable.

13. The monitoring system as claimed in claim 1, characterized in that the monitoring system is adapted for use in at least one of:
(a) a vessel;
(b) a mine;
(c) a building;
(d) a building site;
(e) a petrochemicals facility;
(f) a nuclear-reactor facility;
(g) a plant.

14. A method of using a monitoring system for monitoring spatial positions of one or more user devices within a region, characterized in that the method includes:
(a) arranging for at least one control centre to be in communication, via a constellation of data hubs, with the one or more user devices;
(b) arranging for the one or more user devices to emit signals, which are received by one or more data hubs that are spatially adjacent thereto; and
(c) communicating corresponding signals from the one or more data hubs to the at least one control centre, wherein an identity of the one or more data hubs is provided to the at least one control centre for the at least one control centre to determine therefrom the spatial positions of the one or more user devices.

15. A software product recorded on non-transitory machine-readable data storage media, characterized in that the software product is executable upon computing hardware of a monitoring system to cause the monitoring system to:
(a) in response to emission of signals from one or more user devices, receive the signals at one or more data hubs that are spatially adjacent to the one or more user devices; and
(b) communicate corresponding signals from the one or more data hubs to at least one control centre, wherein an identity of the one or more data hubs is provided to the at least one control centre for the at least one control centre to determine therefrom the spatial positions of the one or more user devices.
